(19) United States
(12) Patent Application Publication
(10) Pub. No.: US 2011/0272361 A1
(43) Pub. Date: Nov. 10, 2011

(54) Materials and Methods for Removing Oil from Bodies of Water

(76) Inventors: Albert E. Ortega, Pensacola, FL (US); James T. Walker, Pensacola, FL (US); William Warren Whitfield, Pace, FL (US); Jim Bostwick, Milton, FL (US)

(21) Appl. No.: 12/787,987

(22) Filed: May 26, 2010

Related U.S. Application Data
(60) Provisional application No. 61/332,473, filed on May 7, 2010.
(60) Provisional application No. 61/345,865, filed on May 18, 2010.

(51) Int. Cl. C02F 1/40; C02F 1/28

(52) U.S. Cl. 210/671; 210/691; 210/693; 210/242.4

(57) ABSTRACT

Strong fabrics with an affinity for oil can be deployed from boats and other sea vessels to absorb oil that has been spilled into oceans, gulfs, rivers, or other bodies of water. For example, strong nylon spunbonded fabrics can be used to soak up oil from bodies of water. The fabrics can also be used in concert with other methods, such as with containment booms.

### CROSS-REFERENCE TO A RELATED APPLICATION

This application claims the benefit of U.S. provisional application Ser. No. 61/332,473, filed May 7, 2010 and U.S. provisional application Ser. No. 61/345,865, filed May 18, 2010, which are incorporated herein by reference in their entirety.

### FIELD OF THE INVENTION

This invention relates to methods of removing oil from seawater using strong fabrics that absorb oil.

### BACKGROUND OF THE INVENTION

Oil spills are an unfortunate accident in the drilling industry. When this happens, the company or companies responsible for the spill mobilize clean up efforts. These efforts involve independent contractors, government organizations, and volunteers. Several methods are used to attempt to recover oil from the water but none are currently very effective. One current method of removing oil from seawater involves containing the material, typically crude oil, from drilling wells and then recovering it using various techniques such as skimmers and absorbent pads.

Skimmers are currently available from many companies. An example of a skimmer is the Magnum 400 available from Elastic/American Marine in Carmi, Ill. This is a mechanical drum system which requires a vessel for deployment along with utilities to run the unit.

Absorbent pads are also placed on top of the spill in an effort to soak up the crude oil and remove it from the water. Currently-used pads are not very strong and break up once they absorb water and oil. They often break apart when the recovery worker lifts the pad onto a vessel or onto land, thereby creating a larger mess. Examples of oil spill recovery pads and other products are available from Interstate Products, Inc. in Sarasota, Fla.

There is a need in the art for a cost effective method to remove oil from bodies of water. A simple method that would not require large vessels or utilities would be advantageous.

### BRIEF SUMMARY OF THE INVENTION

The subject invention provides advantageous methods for removing crude oil, and/or other petroleum products, from water by using fabric that absorbs the oil. Preferably, fabrics used in this method have an affinity for oil and/or petroleum, are able to absorb oil and/or its components, and are strong enough to withstand rigorous deployment and recovery methods.

Many different fabrics can be used, as long as they can withstand the deployment methods and the recovery methods after the fabrics have been loaded with oil. In embodiments of the invention, the fabrics do not break down when exposed to seawater and components in crude oil such as hydrocarbons and petroleum compounds.

The subject invention involves using strong fabrics with an affinity for oil to remove oil from seawater. In a preferred embodiment, strong nylon spunbonded fabrics can be used to remove oil from water dosed with salt. In a specific embodiment, three- and four-ounce per square yard, thermally bonded, nylon nonwoven fabrics can be used to remove oil from water dosed with salt. These fabrics are strong enough to be deployed from small and large boats allowing professional oil recovery contractors, government agencies (e.g., the United States Coast Guard), and volunteers to recover spilled oils in oceans, gulfs, and other bodies of water.

### DETAILED DISCLOSURE OF THE INVENTION

In the following detailed description of the subject invention and its preferred embodiments, specific terms are used in describing the invention; however, these are used in a descriptive sense only and not for the purpose of limitation. It will be apparent to the skilled artisan having the benefit of the instant disclosure that the invention is susceptible to numerous variations and modifications within its spirit and scope.

Fabrics that have an affinity to oil and are strong enough to withstand the rigors of deployment and recovery after saturation with water and oil can be used to clean oil spills in oceans, seas, gulfs, lakes, rivers and other waterways. Woven, nonwoven, needle punched, stitch bonded, and other fabrics made from many materials such as nylons, polyesters, polypropylene, polyethylene, and other polymers can be used as long as they have an affinity for oil. That is, they absorb oil and are strong enough to withstand the rigors of deployment and recovery after saturation with water and oil.

In one embodiment, nylon spunbonded fabrics can be used to soak up oil from saltwater (e.g. seawater). Nylon is known to be chemically resistant to hydrocarbons, like gasoline. Other polymers such as polyethylene, polypropylene, and polyesters are not as chemically resistant to petroleum products as nylon. This will create a shelf life problem if these materials are stored over extended periods where petroleum or hydrocarbon compounds are in the atmosphere or environment. Suitable spunbonded nylon fabrics are available under the trade name CEREX®, PBN-II®, ORION®, and SPECTRAMAX® from Cerex Advanced Fabrics in Cantonment, Fla. These nylon fabrics readily absorb oil and are made with continuous filaments providing superior strength and fabric integrity.

In a preferred embodiment, thermally bonded nylon fabrics, sold under the trade names SPECTRAMAX® and PBN-II® by Cerex Advanced Fabrics, Inc. in Cantonment, Fla. can be attached to the rear of a boat and deployed behind the boat through an oil slick in an ocean, gulf, river, or other body of water that has been contaminated with a spill. If need be, weights can be attached to the end of the fabrics so that the fabric will sink below the surface when dragged behind the boat. Some oil may sink below the surface and may require the fabric to be submerged to come in contact with the oil.

In a specific embodiment, three- and four-ounce per square yard SPECTRAMAX® and PBN-II® can be deployed behind a boat or other vessel and dragged through an oil spill in the Gulf of Mexico to remove a large amount of oil from the water.

In certain embodiments, the method for absorbing oil from water according to the subject invention can include deploying a fabric into the body of water by any reasonable means, for example, by dragging behind a boat, by laying out the fabric over a contaminated area of the body of water, by deploying the fabric between containment booms, or by attaching the fabric to one or more containment booms. The oil being absorbed can be, for example, crude oil spilled into a body of water. The fabric can be, for example, a nylon fabric or a polyester fabric. The method can also include recovering or retrieving the fabric from the water after it has absorbed oil from the water. In preferred embodiments, the fabric should be strong enough such that it does not break when pulled out of the body of water after absorbing the oil (e.g. pulled from the water onto a vessel after absorbing crude oil that had been spilled in the water).

In certain embodiments, the fabric can have a specific gravity in a range of 0.5 to 1.5, 0.9 to 1.5, 0.5 to 1.1, 0.9 to 1.1, 0.95 to 1.05, 0.95 to 1.1, 0.5 to 1.05, 0.9 to 1.05, or 0.95 to 1.5, though embodiments are not limited thereto. In certain embodiments, the fabric can have a specific gravity of greater than 1, greater than 0.9, greater than 1.05, greater than 0.5, greater than 1.1, greater than 0.95, or greater than 1.1, though embodiments are not limited thereto.

In preferred embodiments, the fabric of the subject invention has a minimum strength of 9, 10, 12, 15, 20 or 25 pounds or more in the machine direction and 11, 15, 20, or 25 pounds or more in the cross direction. The elongation in the machine direction may be, for example, 50, 55, 60, or 75% or more in the machine direction and 30, 35, 40, 50, or 60% or more in the cross direction.

The thickness of the fabric may be, for example, 3 to 50 mils, including any thickness or range of thicknesses therebetween.

The size and dimensions of the fabric used can be appropriate for the body of water and the method of deployment. For example, fabric being pulled behind a small boat may be, for example, 0.5, 1, 2, or 3 yards wide and 25, 50, or 100 or more yards long. Fabric deployed from a larger vessel or from a stationary structure, may be, for example, 3, 5, 7, or 10 or more yards wide and 100, 500, 1,000, 5,000 or 10,000 or more yards long.

In certain embodiments, the fabric can be left in a body of water absorbing oil for a period of time sufficient for the fabric to become saturated with oil before recovering the fabric from the water. For example, the period of time can be on the order of seconds, minutes, hours, or days, depending on the material of the fabric and the nature of the oil spill. For example, the fabric can be left in the body of water for a period of time in a range of ten seconds to ten days, ten seconds to one minute, ten seconds to five minutes, ten seconds to ten minutes, one minute to one hour, one minute to ten hours, one minute to fifty hours, ten minutes to one hour, ten minutes to ten hours, ten minutes to one day, ten minutes to fifty hours, one hour to two hours, one hour to ten hours, one hour to one day, one hour to fifty hours, one hour to ten days, ten hours to one day, ten hours to ten days, ten hours to five days, one day to five days, one day to two days, one day to ten days, ten seconds to thirty days, one minute to thirty days, ten minutes to thirty days, one hour to thirty days, ten hours to thirty days, or one day to thirty days, though embodiments are not limited thereto.

Typically, the body of water from which oil is being removed comprises at least 100; 1,000; or 1 million or more cubic yards of water.

In one embodiment, the fabric may be used to hold and/or disperse agents that help to degrade and/or disperse the oil. These agents may be chemical and/or biological. Thus, in one embodiment, the fabric is treated to contain and/or disperse microbes that degrade the oil. For example, the fabric may be sprayed with a solution comprising such microbes as the fabric is being deployed from the vessel. In another embodiment, the fabric may be treated with chemicals that disperse oil. The fabric treated with these dispersing agents can then be deployed into bodies of water containing oil.

In one embodiment, oil that has been absorbed by the fabric is removed from the fabric so that the fabric can then be used again to remove more oil from the water. The removal of the oil can be accomplished by physical, chemical, and/or biological means. For example, because of the strength of the fabric, physical removal of the oil is feasible. This may be accomplished by, for example, wringing the fabric or by running the fabric between rollers. In addition to physical removal of the oil, the fabric may be treated with one or more detergents and/or other appropriate chemicals to remove the oil from the fabric. A further option includes microbial treatment of the fabrics with microbes that are known to degrade oil. The oil thus removed from the fabric may be collected and further used and/or disposed of as appropriate.

In one embodiment the subject invention provides a vessel, such as a boat, that is adapted to deploy the fabric of the subject invention into a body of water. The vessel may have, for example, a structure upon which a roll of fabric can be mounted and deployed into the water. Preferably, the structure would also be capable of retrieving the fabric. In another preferred embodiment, the vessel has a structure to remove oil as the fabric is retrieved. This can be accomplished by, for example, passing the fabric between rollers as it comes aboard the vessel. In a further preferred embodiment, the vessel has a containment area to hold oil that is removed from the fabric. In another embodiment, two or more vessels can be used. One or more can deploy the fabric and at least one other one would retrieve the fabric and remove and hold the oil in a containment area.

Following are examples that illustrate procedures for practicing the invention. These examples should not be construed as limiting.

### Example 1

Spartan EP 320 industrial gear oil available from Mobil was added to water dosed with salt. A 3 osy SPECTRAMAX® nylon spunbonded fabric was used to remove this oil from the water. This fabric is made with continuous nylon filaments that are two denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 2

Number 6 fuel oil was added to water dosed with salt. A 3 osy SPECTRAMAX® nylon spunbonded fabric was used to remove this oil from the water. This fabric is made with continuous nylon filaments that are two denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 3

SAE 30 motor oil was added to water dosed with salt. A 3 osy SPECTRAMAX® nylon spunbonded fabric was used to remove this oil from the water. This fabric is made with continuous nylon filaments that are two denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 4

Spartan EP 320 industrial gear oil available from Mobil was added to water dosed with salt. A 4 osy PBN-II® nylon spunbonded fabric was used to remove this oil from the water. This fabric is made with continuous nylon filaments that are four denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 5

Number 6 fuel oil was added to water dosed with salt. A 4 osy PBN-II® nylon spunbonded fabric was used to remove this oil from the water. This fabric is made with continuous nylon filaments that are four denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 6

SAE 30 motor oil was added to water dosed with salt. A 4 osy PBN-II® nylon spunbonded fabric was used to remove this oil from the water. This fabric is made with continuous nylon filaments that are four denier per filament. Almost all of the oil was removed leaving the water clear. This fabric is strong enough to be attached to the back of a boat or large sea vessel and dragged through the water to soak up crude oil. It is strong enough to be pulled back onto the deployment vessel and collected for safe and proper disposal after becoming saturated with crude oil.

### Example 7

Studies were conducted with two oils to determine absorption for different kinds of fabrics. A highly viscous gear lube oil, Spartan EP 320 by Mobil and a number 4 crude oil that is not as dense were tested. Three inch square pieces of fabric were weighed prior to and after soaking them in oil.

The results using several nylon spunbonded fabrics available from Cerex Advanced Fabrics, Inc. are tabulated below along with the results of melt blown and polyester (REEMAY®) fabrics. STRATYM™ is a multi layered product made by ultrasonically bonding two or more layers of Cerex fabrics together. The 1.4 osy Stratym™ fabric is two layers of 0.7 osy SPECTRAMAX® fabric.

From these results it can be seen that the less dense fabrics tend to absorb better than the denser ones.

| | | % EP320 oil | % Number of 4 |
|---|---|---|---|
| | Basis | absorbed | crude oil |
| | Weight | by weight | absorbed by |
| Fabric | (osy) | of fabric | weight of fabric |
| Melt blown | 4.6 | 1433 | 890 |
| SPECTRAMAX ® | 1.0 | 1086 | n/a |
| SPECTRAMAX ® | 3.0 | n/a | 182 |
| SPECTRAMAX ® | 4.0 | 263 | 128 |
| LOW BOND | 1.0 | 1332 | n/a |
| SPECTRAMAX ® | | | |
| LOW BOND | 3.0 | 592 | 217 |
| SPECTRAMAX ® | | | |
| PBN-II ® | 1.0 | 1086 | n/a |
| PBN-II ® | 2.0 | n/a | 271 |
| PBN-II ® | 3.0 | 400 | 192 |
| PBN-II ® | 4.0 | n/a | 147 |
| LOW BOND PBN-II ® | 2.0 | 611 | n/a |
| STRATYM ™ | 1.3 | 820 | 461 |
| STRATYM ™ | 3.6 | 1114 | 257 |
| Polyester | 1.0 | 450 | 125 |

n/a - this test was not performed

In preferred embodiments, the fabric used absorbs a weight of oil that is at least equal, and preferably 2×, 5×, 10× or more, the weight of the fabric.

It should be understood that the examples and embodiments described herein are for illustrative purposes only and that various modifications or changes in light thereof will be suggested to persons skilled in the art and are to be included within the spirit and purview of this to application and the scope of the appended claims.

What is claimed is:

1. A method for recovering oil from a body of water, comprising:
deploying a fabric into the body of water;
allowing the fabric to absorb oil from the body of water; and
recovering the fabric from the body of water after the fabric has absorbed oil from the body of water.

2. The method according to claim 1, wherein the oil absorbed by the fabric is crude oil.

3. The method according to claim 1, wherein allowing the fabric to absorb oil from the body of water comprises allowing the fabric to absorb oil from the body of water until the fabric is saturated with oil.

4. The method according to claim 1, wherein the fabric is a nylon fabric or a polyester fabric.

5. The method according to claim 1, wherein the fabric is a nylon nonwoven fabric.

6. The method according to claim 5, wherein the oil absorbed by the fabric is crude oil.

7. The method according to claim 5, wherein allowing the fabric to absorb oil from the body of water comprises allowing the fabric to absorb oil from the body of water until the fabric is saturated with oil.

8. The method according to claim 6, wherein allowing the fabric to absorb oil from the body of water comprises allowing the fabric to absorb oil from the body of water until the fabric is saturated with oil.

9. A method for removing oil from a body of water wherein said method comprises deploying, from a vessel, a fabric into the body of water, moving the vessel through the water such that the fabric is pulled behind the vessel thereby contacting and absorbing oil in the water, and removing the fabric, with the absorbed oil, from the water.

10. The method, according to claim 9, wherein the vessels are boats.

11. The method, according to claim 9, wherein the fabric is weighted such that it is pulled at or below the surface of the water.

12. The method, according to claim 9, wherein the body of water is selected from oceans, seas, lakes, gulfs, and rivers.

13. The method, according to claim 9, wherein the surface area of the fabric is at least 100 square yards.

14. The method, according to claim 9, wherein the method further comprises removing from the fabric oil that has been absorbed by the fabric.

15. The method, according to claim 14, wherein said removal of oil comprises physical, chemical, and/or biological treatment of the fabric.

16. The method, according to claim 15, which comprises removing oil by passing the fabric between rollers.

17. The method, according to claim 9, which comprises re-using the fabric to remove more oil from the body of water.

18. A vessel adapted to deploy fabric into a body of water, and to retrieve the fabric.

19. A method for removing oil from a body of water wherein said method comprises deploying, from one or more vessels, a fabric into the body of water, moving one or more vessels through the water such that the fabric is pulled behind one or more vessels thereby contacting and absorbing oil in the water, and removing the fabric, with the absorbed oil, from the water by another vessel that did not originally deploy the fabric.

20. The method, according to claim 19, wherein the vessels are boats.

21. The method, according to claim 19, wherein the fabric is weighted such that it is pulled at or below the surface of the water.

22. The method, according to claim 19, wherein the body of water is selected from oceans, seas, lakes, gulfs, and rivers.

23. The method, according to claim 19, wherein the surface area of the fabric is at least 100 square yards.

24. The method, according to claim 19, wherein the method further comprises removing from the fabric oil that has been absorbed by the fabric.

25. The method, according to claim 24, wherein said removal of oil comprises physical, chemical, and/or biological treatment of the fabric.

26. The method, according to claim 25, which comprises removing oil by passing the fabric between rollers.

27. The method, according to claim 19, which comprises re-using the fabric to remove more oil from the body of water.
